(19) United States
(12) Patent Application Publication
(10) Pub. No.: US 2009/0295203 A1
(43) Pub. Date: Dec. 3, 2009

(54) Pressure Relieving Cushion

(76) Inventors: John Anthony Lewis, Caerphilly (GB); Ian Robert Mahoney, Laleston Close (GB); Howard L. Loewenthal, Hinkley, OH (US)

Correspondence Address: STOCKWELL & SMEDLEY, PSC, 861 CORPORATE DRIVE, SUITE 200, LEXINGTON, KY, 40503, US

(21) Appl. No.: 12/083,710

(22) PCT Filed: Oct. 16, 2006
(86) PCT No.: PCT/GB2006/003812

§ 371 Date: Jul. 13, 2009

Related U.S. Application Data
(60) Provisional application No. 60/727,530, filed on Oct. 17, 2005.

(30) Foreign Application Priority Data
Dec. 23, 2005 (GB) 0526317.3

(51) Int. Cl. A47C 31/00; A47C 16/00; A61G 5/10; A47C 20/02; B68G 5/00

(52) U.S. Cl. 297/219.1; 5/654

(57) ABSTRACT

This invention relates to fluid filled sac suitable for use in or as a pressure relieving cushion and including a fluid containing channel structure formed so as to adopt a state when a user sits on the fluid filled sac in which the flow of fluid to the front of the fluid filled sac is prevented or inhibited.

This invention relates to pressure relieving cushions, sacs suitable for use in or as a pressure relieving cushion, and seats incorporating same Particular, but by no means exclusively, reference is made to sacs and cushions which are suitable for wheelchair users.

It is known that people who spend substantial periods of time in a seated position are prone to develop pressure sores. Those who are unable to make even minor adjustments to their seated position are most vulnerable to the development of pressure sores; wheelchair users and other immobile persons can fall into this category. It is known to utilise specialist pressure relieving cushions in order to ameliorate the problem of pressure sores, and there is an ongoing need to provide new and improved ways of doing so. A known class of pressure relieving cushions utilises a gel sac which seats beneath the user's ischial tuberosites (ITs). Typically, such gel sacs comprise a portion on which the user's ITs rest, and a frontward portion having a plurality of longitudinal tubes which run parallel to one another and extend to the front of the gel sac. The present inventors have identified a problem with such gel sacs, namely that in use the gel in the frontward section tends to migrate to the very front of the gel sac.

The present invention, in at least some of its embodiments, addresses the above described needs and problems.

According to a first aspect of the invention, there is provided a fluid filled sac suitable for use in or as a pressure relieving cushion and including a fluid containing channel structure formed so as to adopt a state when a user sits on the fluid filled sac in which the flow of fluid to the front of the fluid filled sac is prevented or inhibited. The term ‘front’ as used herein is understood to refer to the portion of the fluid filled sac that corresponds to or is adjacent to the front of the cushion in use, i.e. the portion of the cushion over which the legs of the user extend.

The present invention provides numerous ways in which the flow of fluid to the front of the fluid filled sac can be prevented or inhibited. These stem from the present inventors' realisation that, in prior art arrangements with longitudinally extending tubes, there exists a pressure gradient from higher to lower pressure which runs from the seat area of a user along the user's legs to the front of the cushion, thereby propelling gel to the front of the cushion.

In one embodiment, the channel structure includes a plurality of longitudinally inclined fluid containing tubes. By providing longitudinally inclined tubes which do not run in parallel with the user's legs it is possible to prevent or inhibit the flow of fluid to the front of the sac, in particular when a portion of a longitudinally inclined tube extends from underneath a user's leg. Preferably, fluid containing tubes are in the form of a generally herringbone arrangement. A zig-zag pattern may also be adopted.

In another embodiment, the channel structure includes a plurality of fluid containing tubes which extend transversely across the sac. The transversely extending tube may extend from one side of the sac to the other. In this instance, the action of a user sitting on the fluid filled sac propels fluid to the sides of the sac.

In yet another embodiment, the channel structure is in the form of a serpentine or meandering arrangement. It is preferable that the serpentine arrangement extends outside of the area underneath the legs of a user sitting on the sac. In this and other embodiments the weight of the user's thighs may act to close the channel locally so as to either inhibit or prevent the flow of fluid from one end of the channel to the other.

In another embodiment still, the channel structure includes a plurality of fluid containing tubes which are tapered so as to prevent or inhibit the flow of fluid to the front of the fluid filled sac. Preferably, the plurality of fluid containing tubes are tapered towards the front of the fluid filled sac.

The plurality of fluid containing tubes may be generally conical.

In a still further embodiment, the channel structure contains constrictions so as to prevent or inhibit the flow of fluid to the front of the fluid filled sac. Such constrictions may be apertures or other forms of baffling. Alternatively, walls of the general structure may be sealed together at desired locations.

In another further embodiment, the channel structure is a honeycomb structure.

It is preferred that the sac is filled with a gel. However, other fluids, such as a liquid—preferably a relatively high viscosity liquid—or a gas might be utilised.

According to a second aspect of the invention there is provided a pressure relieving cushion comprising a base and a fluid filled sac of the first aspect of the invention disposed directly or indirectly thereon. In embodiments in which the fluid filled sac is disposed indirectly on the base, an intermediate structure may be provided between the fluid filled sac and the base. An example of such intermediate structure is a gas containing sac as described in co-pending patent applications made by the present applicants including U.S. provisional patent applications 60/700,924 and 60/727,291, and International patent application No. PCT/GB2006/002628, the contents of all of which are herein incorporated by reference.

According to a third aspect of the invention, there is provided a pressure relieving cushion comprising a base and a gas containing sac disposed underneath the base, in which gas in the sac is displaceable so that the action of a user sitting on the sac causes one or more portions of the sac to inflate thereby supporting the user on the cushion.

Preferably, the base includes an underside having a cavity in which the gas containing sac is disposed.

The inflated sac may directly support the user on the cushion. Thus, the gas containing sac may have at least one upper inflatable portion extending from underneath the base to an upper surface of the base. The base may have one or more slots through which the upper inflatable portions extend.

In a preferred embodiment, the upper inflatable portions are positioned so as to, when inflated, provide support for the trochanters of the user.

Alternatively or additionally, the action of a user sitting on the sac may cause one or more portions of the sac to inflate so as to support one or more portions of the base thereby supporting the user on the cushion.

In preferred embodiments the gas containing sac includes an inflatable structure having at least front and rear portions, and support regions for supporting the ischial tuberosites and coccyx of a user, gas in the sac being displaceable so that the action of a user sitting on the sac can cause (i) the front and rear portions to be inflated by displaced gas and (ii) the support regions to be suspended from the sac, wherein the inflated front portion causes the pelvis of the user to rotate rearwards and the inflated rear portion provides support behind the coccyx of the user. Gas filled sacs of this type are described in the applicants' co-pending U.S. provisional patent applications 60/700,924 and 60/727,291, and International patent application No. PCT/GB2006/002628.

Preferably, the base is formed from a foam material, most preferably a resilient foam material.

According to a fourth aspect of the invention there is provided a seat including a fluid filled sac according to the first aspect of the invention or a pressure relieving cushion according to the second or third aspect of the invention.

Embodiments of fluid filled sacs and pressure relieving cushions in accordance with the invention will now be described by reference to the accompanying drawings, in which:—

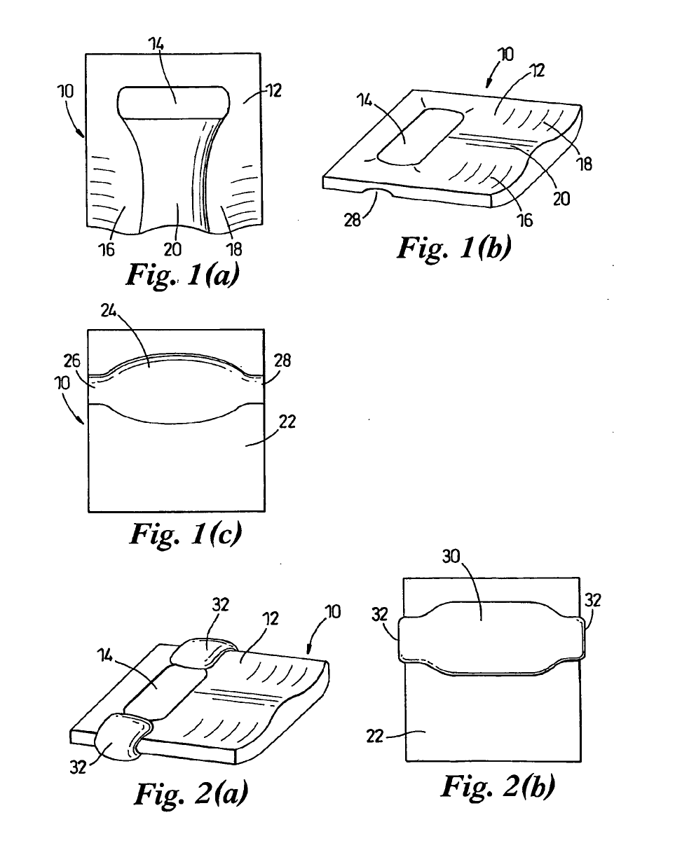

FIG. 1 shows (a) a plan view (b) a perspective sideways view and (c) a view from underneath a base;

FIG. 2 shows (a) a sideways perspective view and (b) a view from underneath a pressure relieving cushion utilising the base shown in FIG. 1;

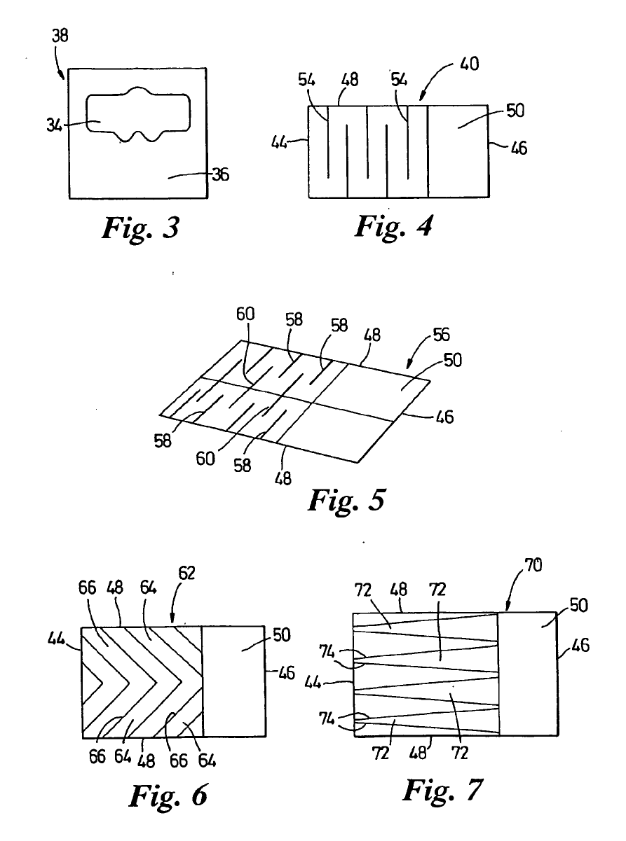

FIG. 3 shows a sideways perspective view of a second embodiment of a pressure relieving cushion;

FIG. 4 shows a first embodiment of a fluid filled sac;

FIG. 5 shows a second embodiment of a fluid filled sac;

FIG. 6 shows a third embodiment of a fluid filled sac;

FIG. 7 shows a fourth embodiment of a fluid filled sac;

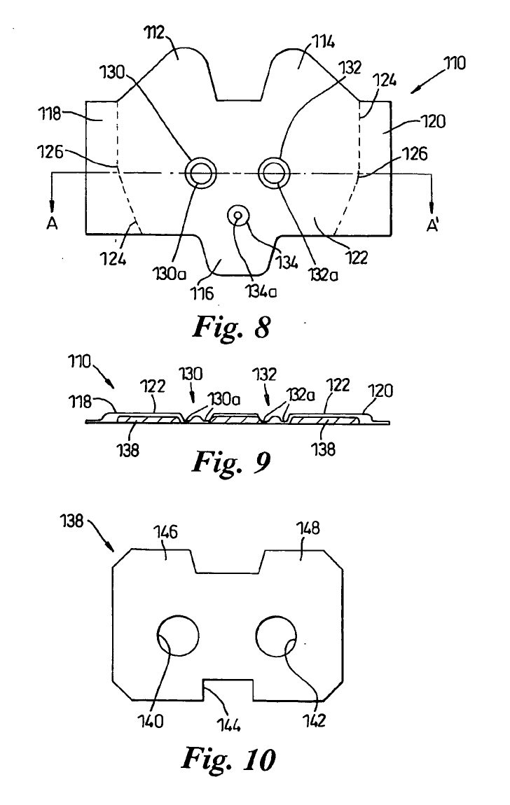

FIG. 8 is a plan view of a first embodiment of a gas containing sac;

FIG. 9 is a cross sectional view along the line A-A′ of FIG. 8;

FIG. 10 is a plan view of a gas distribution layer;

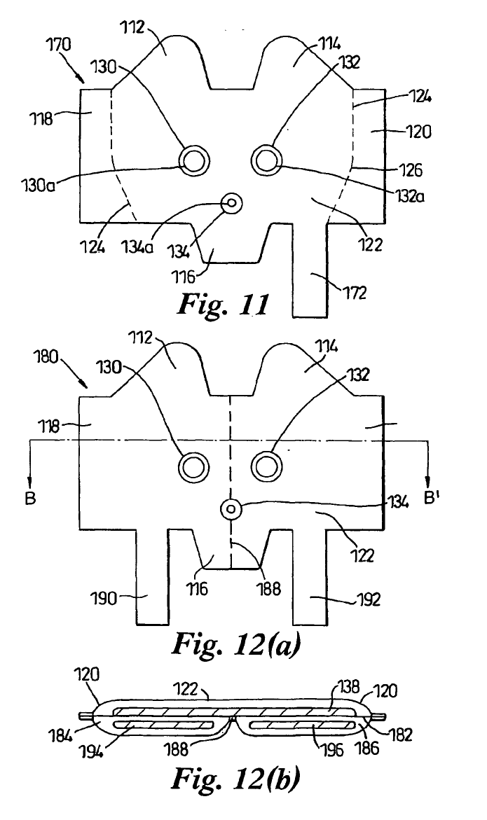

FIG. 11 shows a plan view of a second gas containing sac; and

FIG. 12 shows a third gas containing sac in (a) a plan view and (b) a cross sectional view along the line B-B′ of (a).

FIG. 1 shows a base, depicted generally at 10, suitable for use in a pressure relieving cushion of the invention. The base 10 has an upper surface 12 which includes a recessed region 14 in which the ITs of a user reside during seating, and valley regions 16, 18 separated by a saddle region 20. The legs of a user are positioned in the valley regions 16, 18 during use. The underside of the base 10 comprises a lower surface 22 having a lower cavity 24 and slots 26, 28 extending from the lower cavity 24 to respective sides of the base 10.

FIG. 2 depicts a pressure cushion of the invention in which an air sac 30 is disposed in the lower cavity 24 of the base 10. The air sac 30 has lateral extensions 32 which are located in the slots 26, 28 and extend to the upper surface 12 of the base 10. In use, the action of a user sitting on the pressure relieving cushion causes displacement of air in the air sac 30 thereby inflating the lateral extensions 32. The inflation of the lateral extensions 32 fills voids under the trochanters of the user, thereby helping to support and stabilise the position of the user and reducing pressure on the ITs of the user.

FIG. 3 shows a second embodiment of a pressure relieving cushion in which an air sac 34 is wholly disposed in a cavity formed on a lower surface 36 of a base 38. In this instance, the action of a user sitting on the pressure relieving cushion causes inflation of portions of the air sac 34 which act to support portions of the base 38. In other words, the air sac 34 indirectly supports the user. Air sacs of the type disclosed in the applicants' co-pending U.S. provisional patent applications 60/700,924 and 60/727,291 and in the applicants' co-pending International patent application No. PCT/GB2006/002628 are preferred examples of air filled sacs suitable for use in this arrangement. Suitable air sacs of this type will now be described with reference to FIGS. 8 to 12.

FIGS. 8 and 9 depict a gas containing sac, shown generally at 110, of the present invention. The sac 110 has a pair of front legs 112, 114 and a rear portion/leg 116 extending therefrom. The sac 110 further includes a pair of lateral side regions 118, 120 and main chamber 122. The side regions 118, 120 are separated from the main chamber 122 by join lines 124 wherein the opposed walls of the sac 110 are joined together by a suitable technique. The join lines 124 define channels 126 allowing gas conduction between the side regions 118, 120 and the main chamber 122.

Disposed in the main chamber 122 are a pair of support regions 130, 132 for the ischial tuberosites of a user and a further support region for the coccyx of a user. The support regions 130, 132, 134, which are preferably circular, each have regions 130a, 132a, 134a in the form of a concentric ring in which the surfaces of the sac 110 are joined together. It is possible that the surfaces of the sac 110 might be joined together over the entirety of the supports 130, 132, 134. The supports for the ischial tuberosites 130, 132 and support for the coccyx 134 together define the vertices of an isosceles triangle. It is noted that the relative spacings of the ischial tuberosites and coccyx do not vary substantially amongst adult populations, and therefore it is possible to provide a single sac design having general utility. In one embodiment, the separation between the centres of the supports for the ischial tuberosites is 12 cm, and the separation between the centre of the support for the coccyx and the centre of each support for the ischial tuberosites is 9 cm. Disposed within the main chamber 122 of the sac 110 is a gas distribution layer 138 of a gas permeable material. The gas permeable material may be of any convenient form, such as a fibrous material or a foam material. A relatively loosely layered fibrous material is particularly convenient for this purpose. As shown in FIG. 10, the gas distribution layer 138 has a pair of apertures 140, 142 corresponding to the positions of the supports 130, 132 for the ischial tuberosites of the user. Additionally, the gas distribution layer 138 has a cut out portion 144 corresponding to the position of the support 134 for the coccyx of a user. Further still, the gas distribution layer 138 has a pair of short legs 146, 148 which, when the gas distribution layer 138 is positioned in the sac 110 protrude a short way into the front legs 112, 114 of the sac 110.

The sac 110 is a closed system, and operates by the redistribution of gas when the sac 110 is sat upon by a user. It is undesirable that overly high gas pressures are utilised in the sac when it is not in active use, and in fact a gas pressure at or around atmospheric pressure (101 kPa) is highly suitable. In use, a user sits on the air sac 10. In the configuration shown in FIGS. 8 and 9, the support regions 130, 132, 134 are somewhat indented in comparison to the main chamber 122, thereby assisting in the correct location of the ischial tuberosites and coccyx of the user in the corresponding support region. The action of the user sitting on the sac 110 causes a redistribution of the gas within the sac 110. In particular, gases are expelled from the main chamber 122 into the front legs 112, 114, rear leg 116, and side regions 118, 120, causing these regions of the sac 110 to inflate. A number of advantageous features are associated with this inflation process. The inflation of the front legs 112, 114 causes the front legs 112, 114 to act as flaps or wedges underneath the upper thighs of the user. This action causes the pelvis of the user to be rotated backwards somewhat, causing the user to adopt a more comfortable and medically desirable posture. The inflation of the rear leg 116 also causes the leg 116 to act somewhat in the manner of a flap, providing support for the user behind the coccyx, and additional comfort for the user in the sitting position. The inflation of the side regions 118, 120 causes these regions to rise somewhat, thereby bringing the side regions 118, 120 into contact with the sides of the user's pelvic region, thereby stabilising the user's sitting position and providing further comfort. The overall effect of the inflation of the front legs 112, 114, rear leg 116 and side regions 118, 120 is to increase the surface area of the sac 110 in contact with the user. As a result of this action, the pressure exerted by the user on the sac 110 is reduced. In this regard, a further highly advantageous feature of the invention is that when the user is sitting on the sac 110, causing redistribution of the gas in the sac 110 and inflation of certain regions of the sac, the support regions 130, 132 for the ischial tuberosites and the support region 134 for the coccyx are suspended from the sac 110. It has been found that this process can provide substantial reductions in the pressure transmitted to the sac through contact with a user's coccyx and, in particular, ischial tuberosites. This is advantageous since the present inventors have found that prior art pressure relieving cushions utilising gel sacs can have pressure hot spots associated with contact with the ischial tuberosites of a user.

After use, the user alights from the air sac 110, whereupon gas flows from the inflated regions into the main chamber. The gas distribution layer 138 is particularly convenient in this regard since it tends to assume its original shape once the pressure applied by the user is removed. The expansion of the gas distribution layer 138 on removal of the pressure applied by the user acts rather like a pump, assisting in the redistribution of the gas within the sac 110. The overall effect of the configuration adopted by the sac 110 in use is to increase the surface area in contact with the user and to reduce the pressure exerted by the user on the sac, which thereby reduces the likelihood of pressure sores being developed.

FIG. 11 depicts a second embodiment of a gas containing sac, shown generally at 170. The second embodiment of a gas containing sac 170 shares many of the elements of the first embodiment shown in FIGS. 8 and 9, and identical numerals are used to depict such shared elements. The gas containing sac 170 further comprises a protuberance 172 positioned adjacent the rear portion 116. The protuberance 172 enables the gas pressure in the sac 170 to be adjusted by a user. The gas pressure can be increased by folding or rolling up the protuberance 172, which can be unrolled or unfolded in order to reduce the gas pressure. Advantageously, the gas distribution layer 138 extends into the protuberance 172. Other ways of increasing and decreasing the gas pressure in the gas containing sac can be utilised, such as a valve which might be inflated by a pump or by a user's breath.

FIG. 12 shows a third embodiment of a gas containing sac, shown generally at 180. The third embodiment of a gas containing sac 180 shares a number of the elements of the embodiment shown in FIGS. 8 and 9, and identical reference numerals are used to denote such shared elements. The gas containing sac 180 permits selective inflation/deflation of discrete areas of the sac. The gas containing sac 180 is divided into upper and lower sections by an internal wall 182. The lower section comprises first and second lower chambers 184, 186. The first and second lower chambers 184, 186 are positioned side by side, and are separated by a seal line 188 which extends longitudinally along the gas containing sac 180. The seal line 188 is depicted by a broken line in FIG. 12a, although it is understood that the seal is not part of the upper region of the gas containing sac. The first and second lower chambers 184, 186 are each in communication with a protuberance 190, 192 disposed adjacent to the rear portion 116. The upper portion of the gas containing sac 180 is essentially equivalent to the sac 110 shown in FIGS. 8 and 9. The first and second lower chambers 184, 186 each have a gas distribution layer 194, 196. Each gas distribution layer 194, 196 extends into the corresponding protuberance 190, 192 provided in the relevant lower chamber. Each protuberance 190, 192 can be rolled up or folded in a manner akin to the protuberance of FIG. 11 in order to fine-tune the gas pressure in each lower chamber 184, 186. In this way, the gas containing sac can be inflated so as to compensate for pelvic obliquity. Numerous variations are possible; for example, the first and second lower chambers may not extend to regions corresponding to any or all of the front legs 112, 114, rear portion 116 and lateral side regions 118, 120. Alternatively, a gas containing sac might not possess upper and lower regions separated by an internal wall, but rather comprise two side by side main chambers separated a barrier such as a wall or a seal line. Each of the side by side main chambers could be provided with a separate inflation/deflation device such as a rollable or foldable protuberance.

The gas containing sacs described herein can be conveniently manufactured from plastics materials using well-known techniques. Whilst the invention is particularly applicable to specialist medical applications such as wheelchairs, the invention might be utilised in non-medical applications, where the comfort afforded by the present invention and the ability to settle a user into the correct sitting posture are beneficial.

The invention also provides fluid filled sacs suitable for use in or as a pressure relieving cushion in which the flow of fluid to the front of the fluid filled sac is prevented or inhibited. FIG. 4 shows a first embodiment of a fluid filled sac 40 which has a top surface 42 and a bottom surface (not shown) connected by front edge 44, a rear edge 46 and side edges 48. The fluid filled sac 40 has a rearward region 50 on which the ITs and coccyx of a user are positioned during use. In front of the rearward region 50 and extending to the front edge 44 is a channel structure 52 defined by the side edges 48 and a plurality of interdigitated walls 54 extending from respective side edges 48. Thus, the channel structure 52 defines a serpentine fluid pathway. In prior art arrangements having longitudinally aligned channel structures, fluid in the sac tends to be displaced towards the front during use owing to a longitudinal pressure gradient. Relatively high pressure is exerted by the posterior of the user, with the pressure exerted by the legs tapering off progressively towards the front of the cushion. With the serpentine fluid flowpath provided by the embodiment shown in FIG. 4, there is no progressively reducing pressure gradient along the flowpath and so fluid is not displaced to the front of the sac. In fact, the user's legs may act to pinch the fluid pathway and hence inhibit the forward flow of fluid. Conveniently the interdigitated walls 54 are seal lines between the top and bottom surfaces of the sac, although the use of walls extending between the top and bottom surfaces might be envisaged.

FIGS. 5 to 7 depict various embodiments of fluid filled sacs which share a number of the general features described in respect of FIG. 4: identical numerals are used to denote shared features. FIG. 5 shows a second embodiment of a fluid filled sac 56 in which a series of walls 58 extend from respective side edges 48 of the sac. Additionally, internal walls 60 are positioned with respect to the walls 58 to provide a serpentine fluid pathway.

FIG. 6 shows a third embodiment of an air sac 62 having a plurality of fluid containing tubes 64 defined by walls 66. The plurality of fluid containing tubes are in a generally herringbone arrangement which in this embodiment comprises a chevron arrangement. Other zig-zag arrangements might be contemplated.

FIG. 7 shows a fourth embodiment of an air sac 70 comprising a plurality of fluid containing tubes 72 defined by walls 74. The fluid containing tubes 72 extend longitudinally along the air sac 70, and are generally conically shaped so as to taper towards the front edge 44 of the sac. In this way, the effective pressure gradient exerted by a user can be arranged to be low, thereby minimising the flow of fluid to the front of the sac. Other forms of constriction of the fluid containing tubes might be contemplated.

There are many further embodiments which might be envisaged. For example, the channel structure might comprise a plurality of fluid containing tubes which extend transversely across the sac, or a honeycomb structure. In either instance, fluid can be transported to low pressure regions on either side of the user's legs.

1. A fluid filled sac suitable for use in or as a pressure relieving cushion and including a fluid containing channel structure formed so as to adopt a state when a user sits on the fluid filled sac in which the flow of fluid to the front of the fluid filled sac is prevented or inhibited.

2. A fluid filled sac according to claim 1 in which the channel structure includes a plurality of longitudinally inclined fluid containing tubes.

3. A fluid filled sac according to claim 2 in which the plurality of fluid containing tubes are in the form of a generally herringbone arrangement.

4. A fluid filled sac according to claim 1 in which the channel structure includes a plurality of fluid containing tubes which extend transversely across the sac.

5. A fluid filled sac according to claim 1 in which the channel structure is in the form of a serpentine or meandering arrangement.

6. A fluid filled sac according to claim 1 in which the channel structure includes a plurality of fluid containing tubes which are tapered so as to prevent or inhibit the flow of fluid to the front of the fluid filled sac.

7. A fluid filled sac according to claim 6 in which the plurality of fluid containing tubes are tapered towards the front of the fluid filled sac.

8. A fluid filled sac according to claim 6 in which the plurality of fluid containing tubes are generally conical.

9. A fluid filled sac according to claim 1 in which the channel structure contains constrictions so as to prevent or inhibit the flow of fluid to the front of the fluid filled sac.

10. A fluid filled sac according to claim 1 in which the channel structure is a honeycomb structure.

11. A fluid filled sac according to claim 1 filled with a gel.

12. A fluid filled sac according to claim 1 filled with a liquid.

13. A pressure relieving cushion comprising a base and a fluid filled sac according to claim 1 disposed directly or indirectly thereon.

14. A pressure relieving cushion comprising a base and a gas containing sac disposed underneath the base, in which gas in the sac is displaceable so that the action of a user sitting on the sac causes one or more portions of the sac to inflate thereby supporting the user on the cushion.

15. A pressure relieving cushion according to claim 14 in which the base includes an underside having a cavity in which the gas containing sac is disposed.

16. A pressure relieving cushion according to claim 14 in which the gas containing sac has at least one upper inflatable portion extending from underneath the base to an upper surface of the base.

17. A pressure relieving cushion according to claim 16 in which the base has one or more slots through which the upper inflatable portions extend.

18. A pressure relieving cushion according to claim 16 in which the upper inflatable portions are positioned so as to, when inflated, provide support for the trochanters of the user.

19. A pressure relieving cushion according to claim 14 in which the gas containing sac includes an inflatable structure having at least front and rear portions, and support regions for supporting the ischial tuberosites and coccyx of a user, gas in the sac being displaceable so that the action of a user sitting on the sac can cause (i) the front and rear portions to be inflated by displaced gas and (ii) the support regions to be suspended from the sac, wherein the inflated front portion causes the pelvis of the user to rotate rearwards and the inflated rear portion provides support behind the coccyx of the user.

20. A pressure relieving cushion according to claim 14 in which the base is formed from a foam material, preferably a resilient foam material.

21. A seat including a fluid filled sac according to claim 1.

22. (canceled)

23. A seat including a pressure relieving cushion according to claim 13.

24. A seat including a pressure relieving cushion according to claim 14.
